(19) United States
(12) Patent Application Publication
(10) Pub. No.: US 2024/0399403 A1
(43) Pub. Date: Dec. 5, 2024

(54) PUMP ASSEMBLY COMPRISING ROTATION PREVENTION STRUCTURE

(71) Applicant: YONWOO CO., LTD., Incheon (KR)

(72) Inventor: Hyo Sun JUNG, Incheon (KR)

(21) Appl. No.: 18/699,097

(22) PCT Filed: Oct. 7, 2022
(86) PCT No.: PCT/KR2022/015098

§ 371 Date: Apr. 5, 2024

(30) Foreign Application Priority Data
Oct. 13, 2021 (KR) 10-2021-0136162

(51) Int. Cl. B05B 11/10; F04B 9/14

(52) U.S. Cl. CPC B05B 11/1059; B05B 11/1001; B05B 11/1074; B05B 11/1077; F04B 9/14

(57) ABSTRACT

A pump assembly according to an embodiment of the present invention is provided. The pump assembly coupled to a container part accommodating contents, so as to discharge the contents, may include: a pump part; a shoulder part of which one side is coupled to the container part and the other side is coupled to the pump part so as to couple the pump part to the container part; and a head part coupled to the upper end of the shoulder part so as to eject the contents in response to pressing by a user.

### TECHNICAL FIELD

The present disclosure relates to a pump assembly including a rotation prevention structure, and more specifically, to a pump assembly which has a rotation prevention structure formed on the outer peripheral surface of a shoulder part and the inner peripheral surface of a head part, thereby, even when the head part is pressurized using a bellows type elastic member, preventing rotation of the shoulder part and the head part without collision between the rotation prevention structure and an elastic member.

### BACKGROUND ART

In general, a pump assembly is configured to be coupled to an upper portion of a container body to allow the contents to be discharged to the outside through a pumping action. The pump assembly includes: a pump part which is coupled to the upper portion of the container body, and creates a vacuum state inside the container body to draw up the contents through the pumping action; and a head part which is located above the pump part, and is raised and lowered by user pressure to transfer pressure to the pump part. Here, when a user pressurizes the head part to discharge the contents stored in the container body externally, it is inconvenient in use due to the rotation of the head part caused by pressure.

To overcome the problem, products including rotation prevention structures formed inside the pump assembly have been developed. However, since the rotation prevention structures are mostly formed inside the pump assembly, there is a problem that when the internal volume of the elastic member like a bellows type elastic member varies, the elastic member collides with the rotation prevention structure. Thus, it difficult to form the rotation prevention structure or to freely adopt the shape of the elastic member.

Meanwhile, it is common for a pump container having a pump assembly to have a cover capable of sealing the pump part to prevent contamination of the pump part when the contents are not used. However, in such containers, opening and closing the cover is cumbersome, there is a risk of losing the cover, and if the cover is not coupled, the head part is pressed unintentionally, causing the contents to be discharged and wasted.

Therefore, there is a demand for a pump assembly that can solve such problems.

### DISCLOSURE

### Technical Problem

Accordingly, the present invention has been made in view of the above-mentioned problems occurring in the related art, and it is an object of the present invention to provide a pump assembly including a rotation prevention structure on an outer peripheral surface of a shoulder part and an inner peripheral surface of a head part.

The objects of the present invention are not limited to those mentioned above, and other objects not mentioned herein will be clearly understood by those skilled in the art from the following description.

### Technical Solution

To accomplish the above-mentioned objects, according to the present invention, there is provided a pump assembly, which is coupled to a container part accommodating contents to discharge the contents, including: a pump part; a shoulder part of which one side is coupled to the container part and the other side is coupled to the pump part to couple the pump part to the container part; and a head part coupled to the top of the shoulder part to discharge the contents in response to pressing by a user.

Moreover, at least one rotation prevention protrusion is protrudingly formed on the outer peripheral surface of the shoulder part or on the inner peripheral surface of the head part to prevent the rotation of the shoulder part and the head part.

Furthermore, at least one rotation prevention groove is formed on the outer peripheral surface of the shoulder part or on the inner peripheral surface of the head part to prevent the rotation of the shoulder part and the head part.

Additionally, at least one rotation prevention protrusion protrude on the inner peripheral surface of the head part, and at least one rotation prevention groove is formed on the outer peripheral surface of the shoulder part, thereby preventing the rotation of the head part and the shoulder part by inserting the rotation prevention protrusion into the rotation prevention groove.

In addition, a ring part which extends outward from the outer peripheral surface to a predetermined length and is in contact with at least a portion of the inner peripheral surface of the head part is provided on the upper side of the shoulder part.

Moreover, at least one rotation prevention protrusion protrude on the inner peripheral surface of the head part, and at least one rotation prevention groove is formed on the ring part, thereby preventing the rotation of the head part and the shoulder part by inserting the rotation prevention protrusion into the rotation prevention groove.

Furthermore, the pump part includes: a cylinder opened at the upper portion and the lower portion thereof and has a hollow formed therein; a cylinder cap provided on the inner wall of the cylinder; a sealing part, at least a portion of which is inserted into the cylinder to at least partially seal the upper portion of the cylinder; a piston rod having an inlet formed at the bottom to be opened and closed by the cylinder cap, and a passage formed to the top thereof to be connected to the inlet; a stem coupled to the piston rod to ascend and descend together with the piston rod; and an elastic member provided between the stem and the sealing part to provide elasticity from the sealing part to the stem.

In addition, the elastic member is formed as a bellows type.

### Advantageous Effect

According to the present invention, the pump assembly which includes the rotation prevention structure formed on the shoulder part and the head part can prevent rotation of the shoulder part and the head part when the head part is pressurized, thereby providing convenience in use.

Moreover, according to the present invention, even when the elastic member is formed in a bellows-type, the pump assembly can prevent rotation of the shoulder part and the head part without collision between the rotation prevention structure and the elastic member, and can form the rotation prevention structure regardless of the shape of the elastic member.

Furthermore, according to the present invention, the pump assembly can be converted into the first state where the head part is pressurized or into a second state where the head part is not pressurized by rotating the head part relative to the shoulder part.

In addition, according to the present invention, when the user does not use the pump assembly, the pump assembly can maintain the head part in the second state to prevent pressurization of the head part without any cap or stopper, thereby increasing convenience in storage of the container.

### DESCRIPTION OF DRAWINGS

A brief description of each drawing is provided for better understanding of the drawings referred to in the detailed description of the present invention.

FIG. 1 is an exploded perspective view of a content container according to an embodiment of the present invention.

FIG. 2 is an exploded perspective view of a pump assembly according to an embodiment of the present invention.

FIG. 3 is a sectional view of the pump assembly according to the embodiment of the present invention.

### MODE FOR INVENTION

Hereinafter, exemplary embodiments of the present invention will be described with reference to the accompanying drawings. In the following description, the same components will be designated by the same reference numerals although they are shown in different drawings. Furthermore, in the following description of the present invention, a detailed description of known functions and configurations incorporated herein will be omitted when it may make the subject matter of the present invention rather unclear. In addition, a preferred embodiment of the present invention will be described hereinbelow, the technical thought of the present invention is not restricted or limited thereto and may be embodied in various manners through modification by those skilled in the art. For convenience, directions such as top, bottom, left, and right mentioned below are based on the drawings, and it should be noted that the scope of the present invention is not necessarily limited by the directions.

It will be understood that terms, such as “first” or “second” may be used in the specification to describe various components but are not restricted to the above terms. The terms may be used to discriminate one component from another component. For instance, the first component may be named as the second component, and on the contrary, the second component may be also named as the first component within the scope of the present disclosure. The term, “and/or”, includes a combination of a plurality of related items or any one item among the plurality of related items.

It will be further understood that the words or terms used in the present disclosure are used to describe specific embodiments of the present disclosure and there is no intent to limit the present disclosure. The singular form of the components may be understood into the plural form unless otherwise specifically stated in the context. It should be also understood that the terms of ‘include’ or ‘have’ in the specification are used to mean that there are characteristics, numbers, steps, operations, components, parts, or combinations of the steps, operations, components and parts described in the specification and there is no intent to exclude existence or possibility of other characteristics, numbers, steps, operations, components, parts, or combinations of the steps, operations, components and parts.

Throughout the specification, when a portion is connected to another portion, it may be directly connected to the other portion, or may be indirectly connected to the other portion with another configuration interposed therebetween. In addition, when a portion includes a component, it means that other components may be further included, rather than excluding other components unless otherwise stated.

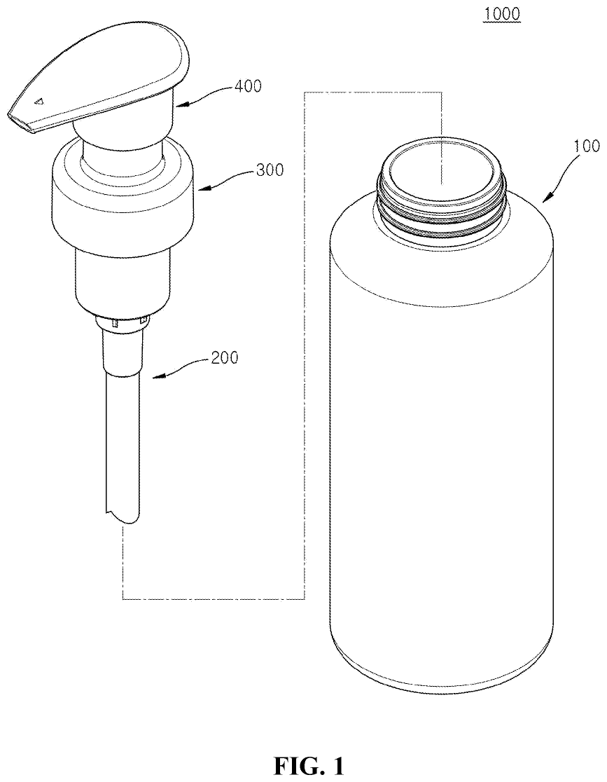

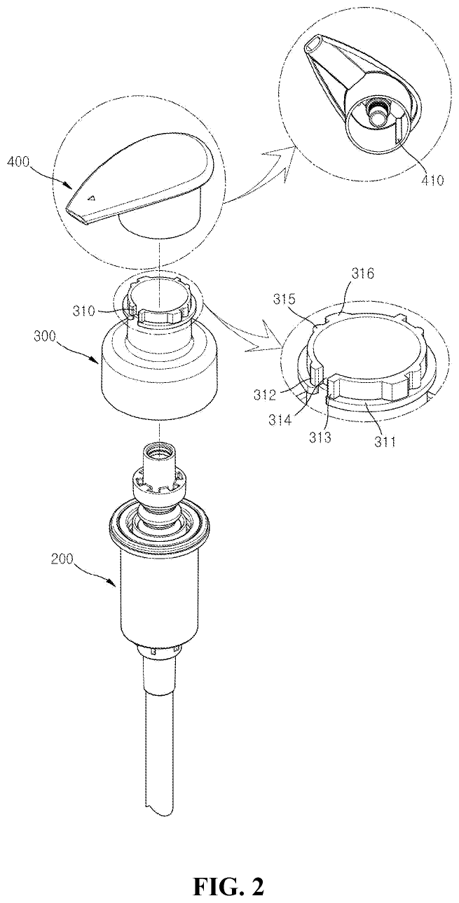

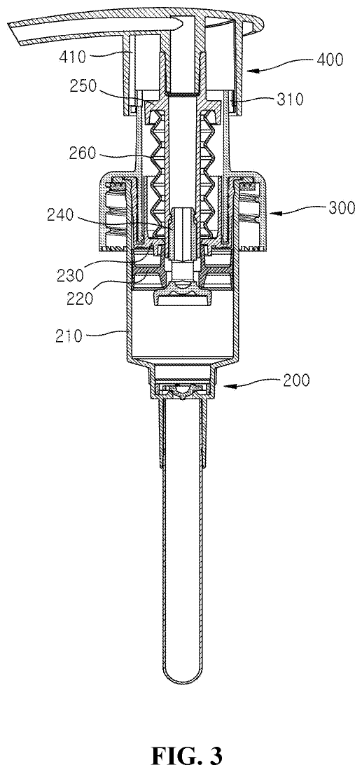

FIG. 1 is an exploded perspective view of a content container according to an embodiment of the present invention, FIG. 2 is an exploded perspective view of a pump assembly according to an embodiment of the present invention, and FIG. 3 is a sectional view of the pump assembly according to the embodiment of the present invention.

Referring to FIGS. 1 to 3, a content container 1000 according to an embodiment of the present invention may include a container part 100 and a pump part 200, a shoulder part 300, and a head part 400.

The container part 100 can accommodate contents. For example, the contents may include cosmetics, pharmaceuticals, and/or non-pharmaceutical items, but are not limited thereto, and may include contents for all disclosed purposes. Additionally, for example, the contents may be in the form of liquid, solid, powder, and/or gas, but are not limited thereto, and may be formed in all disclosed forms.

The container part 100 can include containers of all disclosed forms. For instance, the container part 100 may be a bottle, a jar, a barrel, a case, a tube, a vessel, a tumbler, a cup, or a dispenser container. Additionally, for example, the container part 100 may be formed in the form of a combination of the plurality of containers as described above. Additionally, the aforementioned is merely exemplary, and the container part 100 may include all disclosed forms of containers or combinations thereof.

The pump assembly (200, 300, and 400) can discharge the contents accommodated in the container part 100 by pressurization. For this purpose, the pump assembly (200, 300, and 400) is coupled to the container part 100 to receive external force from a user, thereby allowing inflow and outflow of the contents.

According to an embodiment, the pump assembly (200, 300, and 400) may include a pump part 200, a shoulder part 300, and a head part 400.

At least a portion of the pump part 200 is accommodated within the container part 100, and can move the contents of the container part 100 to the head part 400 through changes in internal pressure. Such pressure changes in the pump part 200 may be due to user pressure applied to the head part 400. According to an embodiment, the pump part 200 may have all disclosed pump structures, and an exemplary structure of the pump part 200 will be described later.

The shoulder part 300 can couple the pump part 200 to the container part 100. For example, the shoulder part 300 may be coupled to the container part 100 on one side and to the pump part 200 on the other side, thereby coupling the pump part 200 to the container part 100. Coupling between the shoulder part 300 and the pump part 200, and/or coupling between the shoulder part 300 and the container part 100 may employ screw coupling, snap coupling, interlocking coupling, and/or dovetail coupling, and all disclosed coupling methods may be applied without limitation.

According to an embodiment, the head part 400 may be coupled to the outer side of the shoulder part 300. Specific details regarding the coupling between the shoulder part 300 and the head part 400 will be described later to avoid redundancy.

The head part 400 can operate the pump part 200 to discharge the contents by user pressure. For this purpose, the head part 400 is coupled to the top of the shoulder part 300 to raise and lower the pump part 200 (for example, a stem 250) by pressure. According to an embodiment, the head part 400 may include an inlet, a passage, and an outlet. For example, the contents discharged from the pump part 200 can be introduced through the inlet, and the introduced contents can be discharged through the outlet after passing through the passage. However, the head part is not limited thereto.

According to an embodiment, at least one rotation prevention protrusion 410 for preventing rotation of the shoulder part 300 and/or the head part 400 may be protrudingly formed on the outer peripheral surface of the shoulder part 300 and/or the inner peripheral surface of the head part 400, or at least one rotation prevention groove 314 may be formed. Specifically, at least one rotation prevention groove 314 may be formed on the outer peripheral surface of the shoulder part 300 (particularly, a ring part 310), and at least one rotation prevention protrusion 410 may be formed on the inner peripheral surface of the head part 400, such that the rotation prevention protrusion 410 can be inserted into the rotation prevention groove 314. When the rotation prevention protrusion 410 is inserted into the rotation prevention groove 314, rotation of the rotation prevention protrusion 410 is restricted, thereby restricting rotation of the head part 400. However, it is merely exemplary, and structures where a rotation prevention protrusion is formed on the shoulder part 300 and a rotation prevention groove is formed on the head part 400 may be applied, and all structures capable of restricting rotation of the shoulder part 300 and the head part 400 are applicable without limitation.

According to an embodiment, the rotation prevention protrusion 410 may be protrudingly formed on the inner surface of the head part 400 without interruption in the longitudinal direction. However, the above is merely exemplary, and the rotation prevention protrusion 410 may be spaced apart at regular intervals in the longitudinal direction and formed discontinuously.

According to an embodiment, the shoulder part 300 is coupled to the inner side of the head part 400, and the shoulder part 300 may be in contact with at least a portion of the inner peripheral surface of the head part 400. For example, a ring part 310 which extends outwardly from the outer peripheral surface to a predetermined length and is in contact with at least a portion of the inner peripheral surface of the head part 400 (especially, the rotation prevention protrusion 410) may be provided on the upper side of the shoulder part 300. In this instance, the head part 400 can rotate along the ring part 310 while being in contact with the ring part 310, and may be changed between a first state and a second state determined by whether the head part 400 is pressurized or not. Specifically, in the first state, the rotation prevention protrusion 410 of the head part 400 is positioned in the rotation prevention groove 314 of the ring part 310, thereby allowing the user to pressurize the head part 400 and discharge the contents. Furthermore, in the second state, the rotation prevention protrusion 410 of the head part 400 may be supported on the upper surface of the ring part 310 (particularly, a limitation portion 311) to prevent the head part 400 from being pressurized even when the user presses the head part 400. Accordingly, when the user uses the content container 1000, the user can position the head part 400 in the first state, and when not using the content container 1000, the user can position the head part 400 in the second state to prevent unnecessary pressurization of the pump part 200, thereby increasing the convenience in storage of the content container 1000.

The ring part 310 may include a limitation part 311, a first guide part 312, a first retaining protrusion 313, a rotation prevention groove 314, a second guide part 315, and a second retaining protrusion 316.

According to an embodiment, the limitation part 311 may be formed on at least a portion of the bottom of the ring part 310. The limitation part 311 may support the end of the rotation prevention protrusion 410 of the head part 400 to ensure that the head part 400 is inserted to a predetermined depth when the head part 400 is coupled to the shoulder part 300 and rotates along the ring part 310. For example, the limitation part 311 may protrude to the extent of contacting the end of the rotation prevention protrusion 410, and the bottom of the limitation part 311 may be open since no limitation part is formed in the rotation prevention groove 314. Thus, when maintaining the second state of the head part 400, the end of the rotation prevention protrusion 410 is supported on the upper surface of the limitation part 311, preventing pressurization of the head part 400 even if the user applies external force to the head part 400. Additionally, when the user rotates the head part 400 along the ring part 310, the insertion depth of the head part 400 can be maintained uniformly, facilitating smoother rotation.

According to an embodiment, a first guide part 312 may be protrudingly formed on one side of the ring part 310. The first guide part 312 may include first and second slope surfaces inclined in the first direction (e.g., clockwise direction) and the second direction (e.g., counterclockwise direction), respectively. In this case, the slope surfaces may mean areas where slip occurs when subjected to a predetermined standard or higher external force, in contact with corresponding slope surfaces. Specifically, when the user couples the head part 400 to the shoulder part 300 and rotates the head part 400 in the first direction, the rotation prevention protrusion 410 of the head part 400 may come into contact with the first guide part 312 and slip along the first slope surface.

According to an embodiment, the ring part 310 may include the first retaining protrusion 313 protruding adjacent to the first guide part 312 in the first direction of the first guide part 312. The first retaining protrusion 313 may include a first retaining jaw formed in the first direction. In this case, the retaining jaw may mean an area where slip does not occur even when an external force is applied, in contact with a corresponding retaining jaw. Specifically, when the user continuously rotates the rotation prevention protrusion 410 slipped along the first guide part 312 in the first direction, the rotation prevention protrusion 410 is supported on the first retaining jaw of the first retaining protrusion 313 not to rotate further.

According to an embodiment, a rotation prevention groove 314 may be formed between the first guide part 312 and the first retaining protrusion 313 of the ring part 310. Since the rotation prevention groove 314 does not have the limitation part 311 and is opened at the bottom, in the first state where the rotation prevention protrusion 410 of the head part 400 is positioned in the rotation prevention groove 314, the user can pressurize the head part 400 to dispense the contents. Additionally, in the first state, since the rotation prevention protrusion 410 cannot slip along the second slope surface of the first guide part 312 until an external force exceeding a certain standard is applied in the second direction, the rotation prevention protrusion 410 remains inserted in the rotation prevention groove 314 to limit the rotation of the shoulder part 300 and the head part 400.

According to an embodiment, adjacent to the first guide part 312 in the second direction of the first guide part 312, a second guide part 315 may be protrudingly formed on the ring part 310. The second guide part 315 may include third and fourth slope surfaces inclined in the first and second directions, respectively. Specifically, when the user rotates the head part 400, which is maintained in the first state, in the second direction, the rotation prevention protrusion 410 of the head part 400 may slip along the second slope surface of the first guide part 312 in contact with the first guide part 312, thereby allowing continuous rotation. Subsequently, the rotation prevention protrusion 410 may slip along the first slope surface of the second guide part 315 in contact with the second guide part 315.

According to an embodiment, the ring part 310 may include the second retaining protrusion 316 protrudingly formed adjacent to the second guide part 315 in the second direction of the second guide part 315. The second retaining protrusion 316 may include a second retaining jaw toward the second direction. Specifically, when the user continuously rotates the rotation prevention protrusion 410 slipped along the second guide part 315 in the second direction, the rotation prevention protrusion 410 may be supported on the second retaining jaw 316 not to rotate further, and may be position in the second state. Therefore, in the second state, since the end of the rotation prevention protrusion 410 of the head part 400 is supported on the upper surface of the limitation part 311, even if the user pressurizes the head part 400, the head part 400 is prevented from being pressurized.

In an embodiment, the first guide part 312 and the second guide part 315 protrude to such an extent as to be in contact with the end of the rotation prevention protrusion 410, and the rotation prevention protrusion 410 may have some resistance and strength to rotate beyond the first guide part 312 and the second guide part 315. Accordingly, the head part 400 can be maintained stably in one of the first and second states.

The pump part 200 may include a cylinder 210, a cylinder cap 220, a sealing part 230, a piston rod 240, a stem 250, and an elastic member 260. However, the above is merely exemplary, the structure of the pump part 200 is not limited thereto, and the pump part 200 may have any pump structure disclosed.

The cylinder 210 may be opened at the top and bottom, and may have an internal cavity. The cylinder 210 may be positioned inside the container part 100, have a first flange formed on the outer surface thereof, and be placed on the container part 100. The bottom of the cylinder 210 may extend toward the inside of the container part 100, and the cylinder may have an inlet communicating with the container part 100. A valve may be provided at or adjacent to the inlet. The valve acts as a check valve, sealing the inlet when the pressure inside the cylinder 210 is positive and opening the inlet when the pressure inside the cylinder 210 changes to negative.

The cylinder cap 220 is for opening and closing the piston rod 240, and may have an outer surface getting in contact with the cylinder 210 and an inner surface getting in contact with the piston rod 240. The inner bottom surface of the cylinder cap 220 may be in close contact with a support part of the piston rod 240 to seal the inlet of the piston rod 240. When the piston rod 240 descends relative to the cylinder cap 220, the bottom of the cylinder cap 220 moves away from the support part of the piston rod 240 to open the inlet and communicate with the inside of the cylinder 210.

The scaling part 230 is coupled to the top of the cylinder 210, and the bottom of the scaling part may extend to the inside of the cylinder 210. In this case, the sealing part 230 may have at least a portion inserted into the cylinder 210 to partially seal the top of the cylinder 210. Specifically, the sealing part 230 may include: a sidewall being in contact with the cylinder 210; a base part formed inward from the bottom of the sidewall; and a second flange extending outward from the bottom of the sidewall. The ascent of the cylinder cap 220 may be inhibited by the bottom surface of the base part. Additionally, the bottom of the elastic member 260 may be supported on the upper surface of the base part, and the elastic member 260 may be prevented from being separated externally due to the sidewall. Furthermore, the second flange may be placed on the top of the container part 100 and/or the first flange of the cylinder 210. According to an embodiment, the bottom of the elastic member 260 may be closely arranged on the sidewall.

The piston rod 240 may be provided inside the cylinder 210, may have the lower side surrounded by the cylinder cap 220, and may be connected to the stem 250 at the top. The piston rod 240 may have a hollow tubular shape, and may include an inlet formed at the bottom of the piston rod 240 and opened and closed by the cylinder cap 220, and an outlet formed at the top of the piston rod 240 for the discharged content to exit therethrough. Additionally, the support part may be formed at the bottom of the piston rod 240, and when the support part gets in contact with the lower inner surface of the cylinder cap 220, the inlet can be sealed from the inner space of the cylinder 210. The piston rod 240 can move vertically inside the cylinder 210 by the stem 250. As the piston rod 240 moves downward, the inlet is opened as the inner bottom of the cylinder cap 220 moves away from the support part, thereby allowing the content inside the cylinder 210 to flow into the piston rod 240. Since the piston rod 240 continues to move, the contents are discharged through the outlet and can be expelled through a discharge hole of the nozzle via the stem 250. When the piston rod 240 moves upward, the cylinder 210 can seal the inlet of the piston rod 240, and negative pressure is generated inside the cylinder 210 to allow the contents inside the container part 100 to flow into the cylinder 210.

The stem 250 can be coupled with the piston rod 240 to ascend and descend together with the piston rod 240. Specifically, when external force is applied, for example, through a nozzle or the like, the stem 250 can lower the piston rod 240 while descending, and when the external force is removed, the stem can raise the piston rod 240 while ascending. The stem 250 may have wing parts protruding outward along the circumference thereof may be formed at the top of the stem. The top of the elastic member 260 may be supported by the bottom surface of the wing part. The length of the accommodation space for the elastic member 260 from the lower surface of the wing part to the upper surface of the base part of the sealing part 230 can be defined.

The elastic member 260 is for restoring the position of the piston rod 240, and may be provided between the stem 250 and the sealing part 230 to provide elasticity toward the stem 250 from the sealing part 230. Specifically, the lower portion of the elastic member 260 may be supported by the scaling part 230 and the upper portion thereof may be supported by the stem 250.

According to an embodiment, the elastic member 260 may be formed as a bellows type. Typically, the pump container having the pump assembly was equipped with the rotation prevention structure formed on the inner surface of the shoulder part to prevent rotation of the head part. However, in the case in which the elastic member of the pump assembly is formed as a bellows type, when pressure is applied to the elastic member, the volume inside the elastic member is changed, so there may occur collision between the rotation prevention structure of the shoulder part and the elastic member. However, in the present invention, the rotation prevention protrusion and/or the rotation prevention groove are respectively formed on the outer peripheral surface of the shoulder part and/or the inner peripheral surface of the head part to solve the above problem.

The content container 1000 illustrated in FIGS. 1 to 3 is exemplary, and various configurations may be applied according to embodiments of the present invention.

As described above, the optimal embodiments has been disclosed in the drawings and the specification. Specific terms have been used herein for descriptive purposes, not for purposes of limitation of meanings or to limit the scope of the invention as set forth in the claims. Therefore, it would be understood by those skilled in the art that various modifications and equivalent embodiments are possible from the present disclosure. Accordingly, the true scope of protection of the present disclosure should be determined by the technical concept of the attached claims.

1. A pump assembly, which is coupled to a container part accommodating contents to discharge the contents, comprising:
a pump part;
a shoulder part of which one side is coupled to the container part and the other side is coupled to the pump part to couple the pump part to the container part; and
a head part coupled to the top of the shoulder part to discharge the contents in response to pressing by a user.

2. The pump assembly according to claim 1, wherein at least one rotation prevention protrusion is protrudingly formed on the outer peripheral surface of the shoulder part or on the inner peripheral surface of the head part to prevent the rotation of the shoulder part and the head part.

3. The pump assembly according to claim 1, wherein at least one rotation prevention groove is formed on the outer peripheral surface of the shoulder part or on the inner peripheral surface of the head part to prevent the rotation of the shoulder part and the head part.

4. The pump assembly according to claim 1, wherein at least one rotation prevention protrusion protrude on the inner peripheral surface of the head part, and at least one rotation prevention groove is formed on the outer peripheral surface of the shoulder part, thereby preventing the rotation of the head part and the shoulder part by inserting the rotation prevention protrusion into the rotation prevention groove.

5. The pump assembly according to claim 1, wherein a ring part which extends outward from the outer peripheral surface to a predetermined length and is in contact with at least a portion of the inner peripheral surface of the head part is provided on the upper side of the shoulder part.

6. The pump assembly according to claim 5, wherein at least one rotation prevention protrusion protrude on the inner peripheral surface of the head part, and at least one rotation prevention groove is formed on the ring part, thereby preventing the rotation of the head part and the shoulder part by inserting the rotation prevention protrusion into the rotation prevention groove.

7. The pump assembly according to claim 1, wherein the pump part comprises:
a cylinder opened at the upper portion and the lower portion thereof and has a hollow formed therein;
a cylinder cap provided on the inner wall of the cylinder;
a sealing part, at least a portion of which is inserted into the cylinder to at least partially seal the upper portion of the cylinder;
a piston rod having an inlet formed at the bottom to be opened and closed by the cylinder cap, and a passage formed to the top thereof to be connected to the inlet;
a stem coupled to the piston rod to ascend and descend together with the piston rod; and
an elastic member provided between the stem and the sealing part to provide elasticity from the sealing part to the stem.

8. The pump assembly according to claim 7, wherein the elastic member is formed as a bellows type.
